(19) United States
(12) Patent Application Publication
(10) Pub. No.: US 2009/0218530 A1
(43) Pub. Date: Sep. 3, 2009

(54) HEATER INSERT

(76) Inventors: Roland Starck, Bellheim (DE); Oleg Kexel, Ettlingen (DE)

Correspondence Address: Walter A. Hackler, Ph.D.;Patent Law Office, 2372 S.E. Bristol Street, Suite B, Newport Beach, CA, 92660-0755, US

(21) Appl. No.: 11/886,285

(22) PCT Filed: Mar. 14, 2006
(86) PCT No.: PCT/EP2006/002311

§ 371 Date: Oct. 6, 2008

(30) Foreign Application Priority Data
Mar. 24, 2005 (DE) 10 2005 013 661.3

(51) Int. Cl. F16K 31/02; G05D 23/02

(52) U.S. Cl. 251/11; 236/101 C

(57) ABSTRACT

The invention relates to a heating element with an electrical resistance heating element, at least one electrical connector line for supplying power to the heating element, a metal body with a connector, through which the at least one connector line and a duct seal, by means of which the connector opening is sealed. The duct seal is embodied with a glass body as a compression glass duct. The invention further relates to a heated expanding material working element for the operation of a thermostatic valve that includes a housing and a moving working rod extending from the housing.

This invention relates to a heater insert with an electric resistance heating element and at least one electric connector lead through which the heating element can be supplied with power. The invention furthermore relates to an expansion material element with a housing and a movable actuation pin passed out of the housing, with the expansion material and such a heater insert being provided in the housing.

Such a heater insert and a heatable expansion material working element are known from WO 02/086646, for example.

Expansion material working elements are used in particular for actuating thermostat valves. In the housing of the expansion material working element, the heater insert heats up the expansion material so that the expansion material expands and pushes the actuation pin out of the housing. A thermostat valve can thus be controlled by supplying electric power to the heater insert.

When heating the expansion material, paraffin for example, a pressure of up to 300 bar arises in the housing of the expansion material working element. Requirements on the tight seal of the expansion material working element are high due to this pressure, in combination with the expansion material's reduced viscosity at elevated temperatures.

One weak point through which expansion material can escape is, in particular, the heater insert with its opening for the at least one connector lead (as a rule, two connector leads are provided).

In the heater insert known from U.S. Pat. No. 7,172,133, the connector leads are embedded in a solid plastic base which is sealed off by an O-ring towards the housing of the expansion material working element.

It has been shown that, during operation, small amounts of expansion material escape through the seal formed by such a plastic base. In the course of time, this results in a reduction of the working stroke and the reaction times of the expansion material working element since a smaller amount of expansion material must be heated up to correspondingly higher temperatures until sufficient pressure is built up to push the actuation pin by the desired length from the housing.

Furthermore, utmost care must be taken in the assembly of the expansion material working element so that no leakage points result through which expansion material can escape between the heater insert and the housing since the plastic base may not be subjected to any major mechanical load.

Accordingly, it is an object of the invention to show a way of how an improved seal can be economically provided for a heater insert of the above-mentioned type and of how such a heater insert can be more easily mounted with a housing.

This object is solved according to the invention by a heater insert with an electric resistance heating element, at least one electric connector lead through which the heating element can be supplied with power, a metal body with a connecting opening through which the at least one connector lead is passed, and a duct seal by means of which the connecting opening is closed, the duct seal being formed with a glass body as a compressed glass-to-metal seal.

A compressed glass-to-metal seal takes advantage of the fact that the metal body has a considerably higher coefficient of thermal expansion than the glass body it surrounds. To produce a compressed glass-to-metal seal, the metal body is heated and glass introduced into the connecting opening with the connector lead passing through it. Upon cooling down to room temperature, the glass body solidifies and contracts. Due to its higher coefficient of thermal expansion, the metal body contracts more than the glass body so that the glass body is pressed with considerable pressure against the embedded connector lead. Thus, a compressed glass-to-metal seal provides an excellent seal not only between the glass body and the penetrating connector lead(s), but also between the glass body and the surrounding metal body.

Aside from the improved tightness, a heater insert according to the invention moreover has the essential advantage that the metal body surrounding the glass body can be combined much more easily with a housing—for example, the metal housing of an expansion material element—than the plastic bases common in prior art with embedded connector leads. This is due to the fact that the metal body can be exposed to considerably greater mechanical loads in the assembly process, due to its much greater hardness compared with plastic materials—without any resulting damages. Moreover, a metal body, a lathe-cut part for example, can be manufactured with smaller tolerances than a plastic part and for that reason can be more easily inserted into the housing of an expansion material working element with the precision required for a tight connection.

While heater inserts with their plastic bases, commonly used in prior art, had to be inserted into an upper, larger opening of a cylindrical housing and be pushed through the housing until the connector lead exits from a smaller opening at the bottom end of the cylindrical housing, a heater insert according to the invention can be inserted, for example, into a lower housing opening, and the edge of this housing opening can be rolled in or flanged to close the opening tightly. In addition, the metal body can be connected with a substance-to-substance bond or a material connection to the housing—it can be welded, in particular—so that an excellent seal can also be reliably provided between housing and metal body. No an additional seal like an O-ring is necessary. It is favorable in this respect to manufacture the housing and the metal body of steel, preferably of stainless steel.

Despite the relatively high expenditure of manufacturing a compressed glass-to-metal seal, a heater insert according to the invention can be produced at a rather reasonable price in comparison with heater inserts known from prior art with plastic bases in which the connector leads are embedded. This is due to the fact that a relatively expensive plastic injection mold is required for embedding the connector leads into plastic bases since the individual connector leads are difficult to handle here. For a heater insert according to the invention, the metal body can be manufactured inexpensively as a stamped part or, preferably, as a lathe-cut part into whose connecting opening a drop of glass can be introduced by relatively simple means to enclose the at least one connector lead.

An additional cost reduction can be achieved with a heater insert according to the invention which uses a nickel/iron alloy for the connector leads. This has the advantage that the at least one connector lead can be inexpensively connected to the heating element by means of welding. Furthermore, nickel/iron alloys have a coefficient of thermal expansion which is excellently suitable for a compressed glass-to-metal seal.

With little expenditure, a plastic body can be injection-molded onto the metal body of a heater insert according to the invention—for example, as a carrier for the heating element or on the other side of the compressed glass-to-metal seal, for example, as the body of a plug-in connector.

Instead of a plastic body, a ceramic body can also be used—especially of polymer ceramics.

Compressed glass-to-metal seals are known in other areas of technology, for example for the housings of electronic semiconductor components with integrated circuitry. For producing compressed glass-to-metal seals and for the selection of materials for the glass body and the metal body enclosing it, reference is made to EP 0574797 B1 which is incorporated by reference into the present application.

A heater insert according to the invention is particularly suitable for a heatable expansion material working element with a housing and a movable actuation pin passed out of the housing, with the expansion material and a heater insert according to the invention being provided in the housing. However, a heater insert according to the invention is also suitable per se for other devices. Accordingly, the subject matter of the invention is also the use of a compressed glass-to-metal seal a connector lead of a heater insert.

Depending on the application of a heater insert according to the invention, the metal body with the compressed glass-to-metal seal can be part of a base or/and part of a housing. In cases in which the heater insert is provided with its own housing, good thermal coupling of the heater insert to the housing is generally desired.

The invention relates furthermore to a thermostat valve with a heatable expansion material element in which a heater insert according to the invention is provided.

### BRIEF DESCRIPTION OF THE DRAWINGS

Additional advantages and features of the invention are explained on the basis of exemplary embodiments with reference to the enclosed drawings. In the Figures:

FIG. 1 shows an exemplary embodiment of an expansion material working element with a heater insert according to the invention, in cross-section;

FIG. 2 shows the compressed glass-to-metal seal of the heater insert in cross-section;

FIG. 3 shows the heater insert without heating element and carrier body in a side view;

FIG. 4 shows the compressed glass-to-metal seal in a top view;

FIG. 5 shows the heater insert without heating element in a side view;

FIG. 6 shows another exemplary embodiment of a heater insert according to the invention in a side view;

FIG. 7 shows the exemplary embodiment shown in FIG. 6 in a cross-sectional view along the intersecting line AA; and

FIG. 8 shows another exemplary embodiment of a heater insert according to the invention.

### DETAILED DESCRIPTION

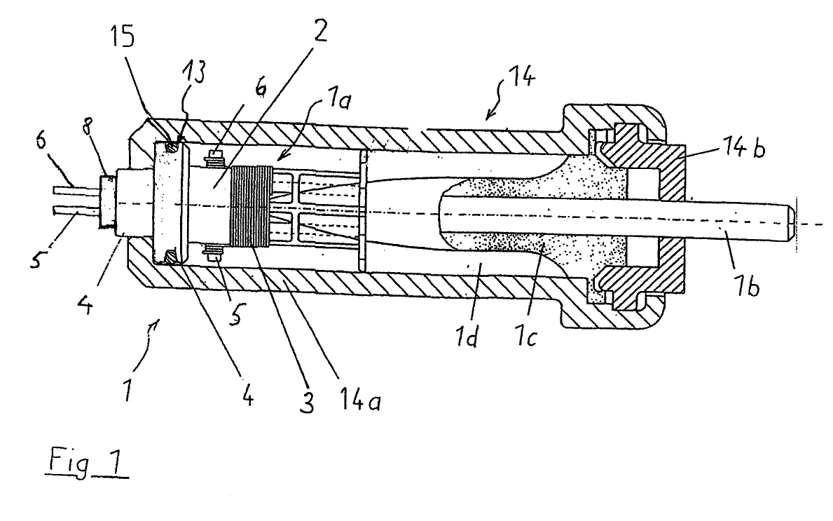

The expansion material working element 1 shown in FIG. 1 comprises an essentially cylindrical housing 14 with a cup-shaped bottom part 14a and a top part 14b which, by flanging of the free front face of the housing part 14a, is firmly connected with it to form the housing 14. A heating device 1a is provided in the area of the bottom part of the housing 14a facing away from housing 14b. Through the top part of the housing 14b, an actuation pin 1b is leading out which is surrounded by a diaphragm 1c within the housing. The other inside space of the housing 14 is filled out with expansion material 1d, for example, paraffin with suitable additives.

The expansion material 1d can be heated with the heater insert 1a so that pressure builds up in the housing 14 by means of which the actuation pin 1b, for example for controlling a thermostat valve, can be pushed out of the housing 14 in relation to the heat applied. Further details on the mode of functioning of heatable expansion material elements are disclosed in U.S. Pat. No. 7,172,133 and therefore need not be explained in more detail.

The heater insert 1a comprises an electric resistance heating element 3 in the form of a PTC heating wire of a nickel/iron alloy, a plastic carrier 2 around which the heating wire 3 is wound, and connector leads 5, 6 which are passed through a base 4. The connector leads 5, 6 are embedded over a part of their length in the plastic carrier 2. It is especially favorable when the resistance heating element 3 as well as the connector leads 5, 6 consist of nickel/iron alloys so that particularly good weldability is provided.

Instead of a heating wire, a thick-layer element can also be used, for example, as a resistance heating element which is held by a carrier, for example, of plastic or ceramic.

In the presented exemplary embodiment, the base is formed by a metal body 4 which is a lathe-cut part of stainless steel. It has a groove 13 in which an O-ring 15 is provided by means of which the metal body 4 is sealed off towards the housing 14. Alternatively, the metal body 4 can also be connected by a positive material connection with the housing 14, preferably by welding or brazing.

In a cross-sectional view, FIG. 2 presents the base of the heater insert 1a formed by a metal body 4. In the metal body 4, a connecting opening 7 is provided in the form of a passage channel through which the two connector leads 5, 6 are passed. Basically, one single connector lead is sufficient if an mass lead is done without. In the passage channel, a glass body 11 of a compressed glass-to-metal seal is provided in which the two connector leads 5, 6 are embedded which consist of a nickel/iron alloy. The metal body 4 is made of stainless steel V2A and therefore has a much higher coefficient of thermal expansion than the glass body 11.

To produce the compressed glass-to-metal seal, the metal body 4 was heated and the glass body 11 was introduced in liquid form in the passage channel. Upon cooling down to room temperature, the glass body 11 solidifies, with the metal body 4—due to its higher coefficient of thermal expansion—contracting more than the glass body 11. Thus, the metal body 4 is pressing with high pressure against the glass body 11 and it, in turn, against the connector leads 5, 6 so that an excellent seal results.

As seen in FIG. 2, the passage channel is only partly filled by the glass body 11. Another part of the passage channel is taken up by a plastic carrier 2 in which the connector leads 5, 6 are embedded over a part of their length. The connector leads 5, 6 are thus additionally stabilized, and a compact heater insert 1a is created which can be easily handled during assembly. The plastic carrier 2 is an injection-molded part formed on the metal body 4.

On the side of the glass body 11 facing away from the plastic carrier 2, a plastic body 8 is injection-molded onto the metal body 4 in which the connector leads 5, 6 are embedded. Thus short circuiting by any unintentional contact between the connector leads 5, 6 or the metal body 4 is prevented. The connector leads 5, 6 feature a bend in their section which is embedded in the plastic body 8 so that the connector leads 5, 6 leave the plastic body 8 with greater spacing between each other.

Thus, despite the small inside diameter of the connecting opening 7 and a diameter of the connector leads 5, 6 of preferably 0.8 mm to 1.2 mm, a space between the two connector leads 5, 6 is achieved by means of which short-circuiting due to any unintentional contact between the connector leads 5, 6 or the metal body 4 can be excluded.

For many applications, the outside diameter of the metal body 4 may not exceed a value of 12 mm, preferably 10 mm in the area of the glass body 11. So that the metal body 4 is not deformed—under the pressure developing during cooling due to the different coefficients of thermal expansion—which might result in an undesirable decrease of the pressure and thus to possible leaks, thickness of its walls in the area of the glass body 11 should amount to at least 0.8 mm, preferably to 1.0 mm, better to at least 1.5 mm. Due to the increasing miniaturization of thermostat valves, the inside diameter of the connecting opening of the passage channel is thus preferably approximately 4 mm to 6 mm. These data apply in case that only one connecting opening is provided. The inside diameters and wall gauges can be reduced in case of a metal body 4 with two connecting openings through which one connector lead each is passed through.

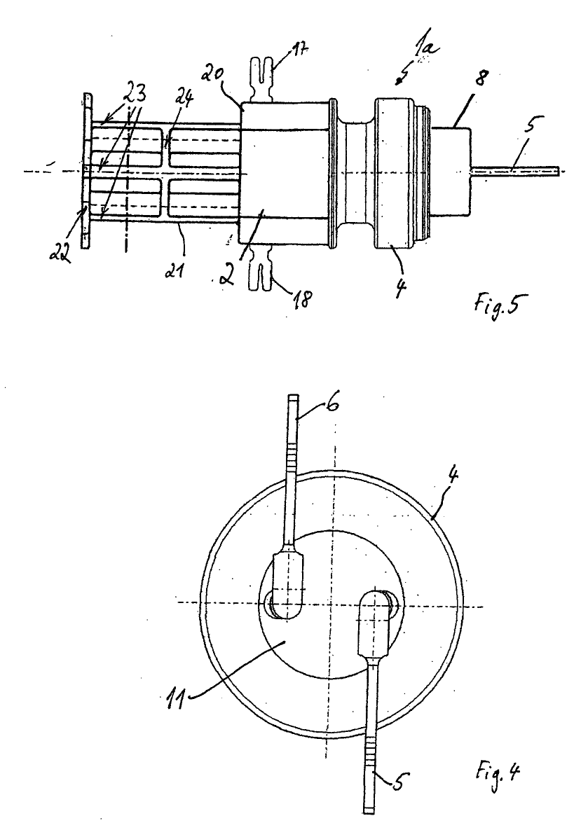

FIG. 4 shows the compression glass-to-metal seal in a top view. At their end facing the heating element 3, the connector leads 5, 6 are bent in different directions, preferably in opposite directions to be able to protrude from the plastic carrier 2 not shown here.

FIG. 5 shows the heater insert 1a without the heating element in a side view. The plastic carrier 2 is molded to the metal body 4 as an injection-molded part. The connector leads 5, 6 are embedded in the plastic carrier 2 and provided on their ends with bifurcated connection elements 17, 18 to which the heating wire 3 is fastened, preferably by welding. The plastic carrier 2 has a base 20 projecting into the metal body 4 and a coil form 21 around which the heating wire is wound. The coil form 21 is followed by a ring 22 which centers the heater insert 1a in the housing 14 of the expansion material working element 1. The coil form 21 is formed by longitudinal ribs 23 and transverse ribs 24 between which openings are provided.

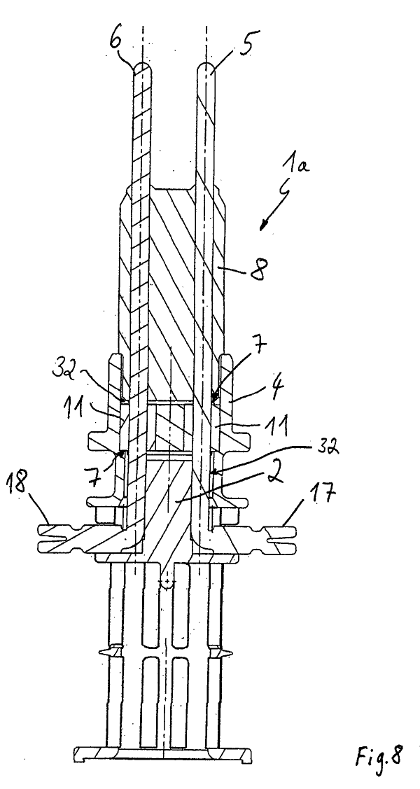

In the exemplary embodiment described, the metal body 4 of the heater insert 1a comprises a connecting opening 7 through which two connector leads 5, 6 are passed. It is also possible, however, to provide a separate connecting opening in the metal body 4 for each connector lead. Then, according to FIG. 8, the metal body 4 preferably comprises a blind hole 32 into which the plastic carrier 2 protrudes. It is advantageous when the metal body forms blind holes on both sides of the connecting openings.

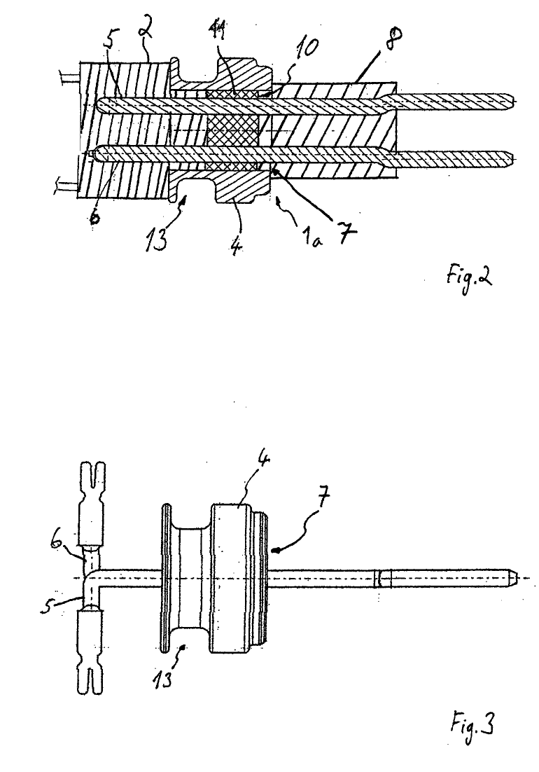

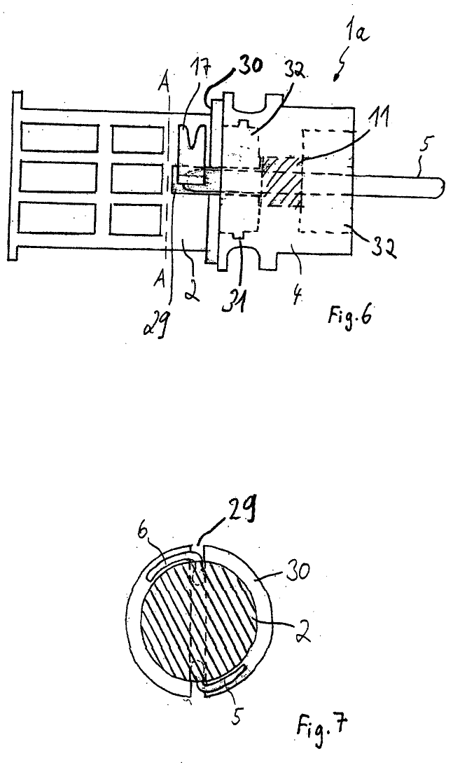

The exemplary embodiment shown in FIG. 6 differs from the exemplary embodiment explained on the basis of FIGS. 2 to 5 essentially by the fact that the plastic carrier 2 was not injection-molded to the metal body 4 around the connector leads 5, 6, but was provided to the metal body 4 by means of a pressure fit or a clip connection. Alternatively or additionally, the plastic carrier 2 can furthermore be fastened by adhesive bonding to the metal body and/or the glass body 11. It is advantageous to use the connector leads 5, 6 additionally to fasten the plastic carrier 2 on the metal body 4, by bending the connector leads 5, 6 and thus forming a positive fit with the plastic carrier 2.

FIG. 7 shows the exemplary embodiment shown in FIG. 6 along the intersecting line AA. The connector leads 5, 6 are passed through a slot 29 in the plastic carrier 2 and bent in circumferential direction of the plastic carrier 2 so that they form a positive fit with an annular surface 30 of the plastic body. Of course, several separate slits can also be used instead of one single slot 29. It is particularly advantageous if the connector leads 5, 6 contact the annular surface 30 of the plastic carrier 2. It is principally sufficient, however, if the connector leads 5, 6 are provided along the annular surface 30 so that, upon the plastic carrier pulling from the metal body 4, they will press against the annular surface 30 and thus prevent a removal of the plastic carrier 2.

A particularly strong and heavy-duty connection of the plastic carrier 2 with the metal body 4 can be achieved, in particular, by the connecting opening 7 of the metal body 4 being undercut so that the plastic carrier has a positive fit connection with the metal body 4. An undercut 31 of the metal body 4 is advantageous not only with the preferred injection molding of the plastic carrier 2 to the metal body 4 but also for the adhesive bonding and/or clipping of the plastic carrier 2 into the metal body 4.

FIG. 8 shows another exemplary embodiment of a heater insert 1a according to the invention in a sectional view which essentially differs from the exemplary embodiment described on the basis of FIGS. 2 to 5 by the metal body 4 comprising two connecting openings 7 which each enclose a glass body 11 and through which one of the connector leads 5, 6 each is passed. In this embodiment, the passage channel forming the connecting openings 7 comprises the two blind holes 32 in whose bottom the connecting openings 7 are provided.

In the presented exemplary embodiment, the connecting openings 7 are formed as bore holes in the metal body 4 between the cylindrical blind holes 32 and are accordingly circular. The use of two connecting openings for the two connector leads 5, 6 has the advantage that, for sealing the connecting openings 7, smaller glass bodies 11 are sufficient and consequently, the wall thickness of the metal body 4 in the area of the glass bodies 11 can be reduced. The heater insert 1a can thus be produced smaller overall and more compact. Furthermore, straight guiding of the connector leads 5, 6 is facilitated by thinner outside walls of the metal body 4. The outside wall thickness for a metal body 4 with two connecting openings 7 through which one connector lead each is passed preferably lies between 0.5 mm and 1 mm, especially preferably between 0.6 mm and 0.8 mm. The diameter of the connecting openings preferably lies between 1.5 mm and 2.5 mm, especially preferably between 1.8 mm and 2.2 mm.

### LIST OF REFERENCE NUMBERS

1. Expansion material element
1a Heater insert
1b Actuation pin
1c Diaphragm
1d Expansion material
2. Plastic carrier
3. Heating element
4. Metal body
5. Connector lead
6. Connector lead
7. Connecting opening
8. Plastic body
10. duct seal
11. Glass body
13. Annular groove
14. Housing
14a Bottom part of housing
14b Top part of housing
15. O-ring
17. bifurcated connection element
18. bifurcated connection element
20. Base
21. Coil form
22. Ring
23. Longitudinal ribs
24. Transverse ribs
29. Slot
30. Annular surface
31. Undercut
32. Blind hole

1. Heater insert with
an electric resistance heating element (3);
at least one electric connector lead (5, 6) by means of which the heating element (3) can be supplied with power;
a metal body (4) with a connection opening (7) through which the at least one connector lead (5, 6) is passed; and a duct seal (10) by means of which the connecting opening (7) is closed,
the duct seal (10) being formed with a glass body (11) as a compression glass-to-metal seal.

2. Heater insert according to claim 1, characterized in that the at least one connector lead (5, 6) is embedded on part of its length in a plastic carrier (2) or a ceramic carrier.

3. Heater insert according to claim 2, characterized in that the carrier (2) contacts the glass body (11).

4. Heater insert according to claim 2 or 3, characterized in that the metal body (4) comprises a passage channel forming the connecting opening (7) which is partly filled by the glass body (11) and partly by the carrier (2).

5. Heater insert according to any one of the claims 2 to 4, characterized in that the carrier (2) is an injection-molded part formed on the metal body (4).

6. Heater insert according to any one of the claims 2 to 5, characterized in that the carrier (2) carries the heating element (3).

7. Heater insert according to any one of the claims 2 to 6, characterized in that the heating element (3) is a heating wire which is wound around the carrier (2).

8. Heater insert according to any one of the preceding claims, characterized in that the at least one connector lead (5, 6) is made of a nickel/iron alloy.

9. Heater insert according to any one of the preceding claims, characterized in that the heating element (3) is a PTC thermistor.

10. Heater insert according to any one of the preceding claims, characterized in that the heating element (3) is made of a nickel/iron alloy.

11. Heater insert according to any one of the preceding claims, characterized in that two connector leads (5, 6) are passed through the connecting opening (7) and bent in different directions, preferably opposite directions at their end which is facing the heating element (3).

12. Heater insert according to any one of the preceding claims, characterized in that the connecting opening (7) of the metal body (4) comprises an inside diameter of at least 4 mm to a maximum of 6 mm.

13. Heater insert according to any one of the preceding claims, characterized in that the metal body (4), where it surrounds the glass body (11), comprises an outside diameter of a maximum of 12 mm, preferably a maximum of 10 mm.

14. Heater insert according to any one of the preceding claims, characterized in that the at least one connector lead (5, 6) has a diameter of 0.7 mm to 1.5 mm.

15. Heater insert according to any one of the preceding claims, characterized in that the connector leads (5, 6) as well as the heating element are of nickel/iron alloys.

16. Heater insert according to any one of the preceding claims, characterized in that the passage channel of the metal body (4) is undercut.

17. Heater insert according to any one of the preceding claims, characterized in that the carrier (2) is connected in a positive fit with the metal body (4).

18. Heater insert according to claim 17, characterized in that the carrier (2) is additionally connected with the metal body (4) by friction lock and/or in an adhesive bond.

19. Heater insert according to any one of the preceding claims, characterized in that the metal body (4) comprises two connecting openings (7) through which one each of the connector leads (5, 6) is passed.

20. Heater insert according to any one of the preceding claims, characterized in that the carrier (2) is held in a positive fit by the connector leads (5, 6) to the metal body (4).

21. Heatable expansion material element, especially for the actuation of a thermostat valve, with a housing (14), and a movable actuation pin (1b) passed out of the housing (14), with expansion material (1d) and a heater insert (1a) being provided in the housing, characterized in that the heater insert (1a) is designed according to any one of the preceding claims.

22. Expansion material working element according to claim 21, characterized in that the metal body (4) of the heater insert (1a) is connected by a substance-to-substance bond with the housing (14), preferably by welding or hard soldering.

23. Thermostat valve with a heatable expansion material working element according to claim 21 or 22.

24. Use of a prestressed glass penetration for a connector lead (5, 6) of a heater insert (1a).
